(19) United States
(12) Patent Application Publication
(10) Pub. No.: US 2026/0105676 A1
(43) Pub. Date: Apr. 16, 2026

(54) METHOD, APPARATUS, ELECTRONIC DEVICE AND STORAGE MEDIUM OF GENERATING THREE-DIMENSIONAL GAUSSIAN PARAMETERS

(71) Applicants: Beijing Zitiao Network Technology Co., Ltd., Beijing (CN); Peking University, Beijing (CN)

(72) Inventors: Chenguo LIN, Beijing (CN); Panwang PAN, Beijing (CN); Yadong MU, Beijing (CN)

(21) Appl. No.: 19/359,535

(22) Filed: Oct. 15, 2025

(30) Foreign Application Priority Data
Oct. 15, 2024 (CN) 202411441710.8

(51) Int. Cl. G06T 15/00

(52) U.S. Cl. CPC G06T 15/00

(57) ABSTRACT

The present disclosure provides a method, an apparatus, an electronic device and a storage medium of generating 3D Gaussian parameters. The method of generating 3D Gaussian parameters comprises: obtaining a target text, the target text being a description text of a target 3D object; and inputting the target text into a pretrained target model to cause the target model to generate 3D Gaussian parameters of a target 3D object conforming to the target text, wherein the pretrained target model is obtained by adjusting a pretrained text-to-image model to obtain an initialized target model and then training the initialized target model, and wherein the text-to-image model is a model for generating, based on an input text, a two-dimensional (2D) image conforming to the input text.

### CROSS-REFERENCE TO RELATED APPLICATION(S)

The present application claims priority to Chinese Patent Application No. 202411441710.8, filed on Oct. 15, 2024, and entitled “METHOD, APPARATUS, ELECTRONIC DEVICE AND STORAGE MEDIUM OF GENERATING THREE-DIMENSIONAL GAUSSIAN PARAMETERS”, which is hereby incorporated by reference in its entirety.

### FIELD

The present disclosure relates to the field of computer technology, and in particular, to a method, an apparatus, an electronic device and a storage medium of generating three-dimensional (3D) Gaussian parameters.

### BACKGROUND

By using a trained model, a user may input a textual description to generate an image. This technique is widely applied in various fields. Compared to two-dimensional (2D) data, 3D data are fewer with diverse 3D representations, and there are still many challenges in generating corresponding 3D data by inputting text.

There has been proposed scalable latent neural fields diffusion for speedy 3D generation (LN3Diff) in related technologies. The solution consists of two parts: the first part is a triplane variational autoencoder (VAE), wherein an encoder of the VAE receives multi-view RGB images, depth images and the Plucker embedding which represents view angle information, and compresses them into a latent space, and then a decoder of the VAE decodes the features compressed into the latent space into a neural radiance field (NeRF) represented by the triplane, and supervised training of the VAE is performed by rendering the multi-view images in comparison with real images. The second part is a diffusion generating model trained on a triplane latent space, with the specific network as a diffusion transformer (DiT), which is trained similarly to latent diffusion models (LDM) widely used in the field of image generation, such as a stable diffusion model.

### SUMMARY

The present disclosure provides a method, an apparatus, an electronic device and a storage medium of generating 3D Gaussian parameters.

The present disclosure applies the following technical solutions.

In some embodiments, the present disclosure provides a method of generating 3D Gaussian parameters, comprising:
obtaining a target text, the target text being a description text of a target 3D object; and
inputting the target text into a pretrained target model to cause the target model to generate 3D Gaussian parameters of a target 3D object to conform to the target text;
wherein the pretrained target model is obtained by adjusting a pretrained text-to-image model to obtain an initialized target model and then training the initialized target model; and
the text-to-image model is a model for generating, based on an input text, a two-dimensional (2D) image conforming to the input text.

In some embodiments, the present disclosure provides an apparatus of generating 3D Gaussian parameters, comprising:
an obtaining unit configured to obtain a target text, the target text being description text of a target 3D object; and
a control unit configured to input the target text into a pretrained target model to cause the target model to generate 3D Gaussian parameters of a target 3D object to conform to the target text;
wherein the pretrained target model is obtained by adjusting a pretrained text-to-image model to obtain an initialized target model and then training the initialized target model; and
the text-to-image model is a model for generating, based on an input text, a two-dimensional (2D) image conforming to the input text.

In some embodiments, the present disclosure provides an electronic device, comprising: at least one memory and at least one processor;
wherein the memory is configured to store program codes, and the processor is configured to call program codes stored in the memory to perform the above method.

In some embodiments, the present disclosure provides a computer readable storage medium, configured to store program codes which, when run by a processor, cause the processor to perform the above method.

### BRIEF DESCRIPTION OF THE DRAWINGS

Through the following detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn to scale.

FIG. 1 illustrates a flowchart of a method of generating 3D Gaussian parameters according to an embodiment of the present disclosure;

FIG. 2 illustrates a schematic diagram of a variational encoder of a target model according to an embodiment of the present disclosure;

FIG. 3 illustrates a schematic diagram of adjusting the target model by using a diffusion loss function component and a rendering loss function component according to an embodiment of the present disclosure;

FIG. 4 illustrates a schematic diagram of the effects generating a 3D content from a text by using the target model according to an embodiment of the present disclosure;

FIG. 5 illustrates a schematic diagram of the effects of using and not using the rendering loss function component;

FIG. 6 illustrates a schematic diagram of the effects of not using and using the ControlNet technique; and

FIG. 7 illustrates a structural schematic diagram of an electronic device according to an embodiment of the present disclosure.

### DETAILED DESCRIPTION OF EMBODIMENTS

It is to be understood that, before applying the technical solutions disclosed in various embodiments of the present disclosure, the user may be informed of the type, scope of use, and use scenario of the personal information involved in the present disclosure in an appropriate manner in accordance with relevant laws and regulations, and user authorization may be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window; and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

It is to be understood that data involved in the present technical solution (including but not limited to the data itself, the acquisition or use of the data) should comply with requirements of corresponding laws and regulations and relevant rules.

The embodiments of the present disclosure will be described in more detail with reference to the accompanying drawings, in which some embodiments of the present disclosure have been illustrated. However, it is to be understood that the present disclosure can be implemented in various manners, and thus may not be construed to be limited to embodiments disclosed herein. On the contrary, those embodiments are provided for the thorough and complete understanding of the present disclosure. It is to be understood that the drawings and embodiments of the present disclosure are only used for illustration, rather than limiting the protection scope of the present disclosure.

It is to be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise/include” and their variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modification “one” mentioned in the present disclosure is illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

The solutions provided by the embodiments of the present disclosure will be described in detail in conjunction with the accompanying drawings.

With the development of computer-aided generation technology, the technology of generating 3D content through text is widely used in various fields.

The scale of existing 3D datasets is much smaller than that of 2D image datasets, and there are a large number of low-quality samples in the 3D datasets. The lack of high-quality 3D samples and their corresponding textual descriptions poses a great challenge to train models for generating 3D content through text.

The text-to-image model uses 2D datasets for training. In the related technologies, models of 3D content fail to make effective use of the priori knowledge obtained from pretraining in the text-to-image model, but only can utilize these small-scale and lower-quality 3D datasets, limiting the quality of generated 3D content as well as the accuracy of matching with text.

In related technologies, a model for generating 3D content only uses a common diffusion denoising loss function to train the model. This puts a very high demand on the variational encoder that compresses the 3D representation into the latent space, because its reconstruction quality determines the upper limit of the model, and may prevent the model for generating 3D content from reaching its full potential.

In related technologies, the architecture of the model for generating 3D content differs significantly from that of the image generation field in terms of the input and output format, making it impossible to directly migrate some of the techniques matured in the image generation field to the 3D generation field, and posing difficulties in expanding the downstream tasks in the 3D generation field.

In related technologies, the 3D representation obtained by the model for generating 3D content is based on the tri-plane of the neural radiation field NeRF, and its rendering uses the relatively computationally expensive ray tracing technique, wherein the rendering operation occurs during model training as well as inference, making the training and inference stages rather time-consuming.

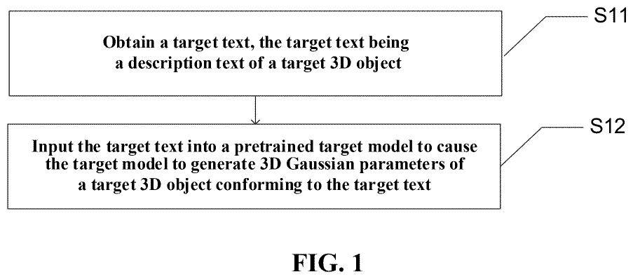

As shown in FIG. 1, this figure is a flowchart of a method of generating 3D Gaussian parameters according to an embodiment of the present disclosure, the method comprising the following.

S11, a target text is obtained, and the target text is a description text of a target 3D object.

In some embodiment, the target text may be a text input by the user, which describes which type of 3D objects the user wants to generate, e.g., “red apples”. The target 3D object may be a 3D object the user wants to generate. The target text may be received from the user via text or voice input.

S12, the target text is input into a pretrained target model to cause the target model to generate 3D Gaussian parameters of a target 3D object to conform to the target text.

In some embodiments, the target model may be a neural network model, and may specifically comprise a variational encoder and a denoising network. The input of the target model comprises a text, the output of the target model comprises 3D Gaussian parameters, the target text may be input into the denoising network which outputs the 3D Gaussian parameters of the target 3D object (the output may be 3D Gaussian parameters under multiple angles of view, and 3D Gaussian parameters may take the form of latent representations). 3D Gaussian parameters describe the shape structure, color, transparency and other information of the target 3D object. The target model has been pretrained before use, wherein the pretrained target model (i.e., trained in advance) is obtained by adjusting a pretrained text-to-image model to obtain an initialized target model and then training the initialized target model, and the text-to-image model is a model for generating, based on an input text, a two-dimensional (2D) image conforming to the input text. The text-to-image model may be an existing model in the related technologies, such as a Stable Diffusion model. PixArt-alpha model. PixArt-Sigma model. FLUX model, etc. Specifically, after the 3D Gaussian parameters are obtained, a 2D image of the target 3D object at any angle may be further generated based on the 3D Gaussian parameters.

In some embodiments of the present disclosure, the pretrained text-to-image model is adjusted to obtain an initialized target model, and the trained text-to-image model may directly generate 3D Gaussian parameters. Unlike using small-scale 3D datasets to train generation networks from the beginning in the prior art, in some embodiments of the present disclosure, the priori knowledge of the text-to-image model pretrained on large-scale datasets is fully utilized and is migrate to the 3D generation field. For the text-to-image model, it is trained using large-scale 2D image datasets, so the text-to-image model includes the priori knowledge trained using 2D image datasets. The trained text-to-image model is adjusted to obtain the target model, and such a target model inherits the priori knowledge in the text-to-image model which is migrated to the 3D generation field. In some embodiments, the target 3D object is represented as multi-view 3D Gaussian splatting (3DGS), and the priori knowledge obtained from pre-training on large-scale 2D image datasets are migrated to 3D Gaussian parameters generation task.

In some embodiments, adjusting the pretrained text-to-image model to obtain the initialized target model comprises: obtaining the pretrained text-to-image model: copying rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and determining the text-to-image model with the adjusted convolutional layer (i.e., the text-to-image model with rows or columns of convolutional layer network parameters being copied for n times) as the initialized target model.

In some embodiments, the text-to-image model is pretrained using 2D images, and the convolutional layer of the text-to-image model is a three-channel for processing RGB of a 2D image. To enable the channel to process 3D Gaussian parameters, the channel needs to be expanded. The number of parameters in the 3D Gaussian parameters is usually 12, so n may be 4, i.e., if the 3D Gaussian parameters are a multiple of 3, the expanded multiple n is the number of parameters in the 3D Gaussian parameters divided by 3: if the number of parameters in the 3D Gaussian parameters is not a multiple of 3, then the number of parameters in the 3D Gaussian parameters is divided by 3, 1 plus the integer part of the resulting quotient is determined as n. At this point, 3n is greater than the number of parameters in the 3D Gaussian parameters, the rows or columns of the convolution layer network parameters include portions that fail to correspond to the 3D Gaussian parameters, and these portions are subjected to a complementary-zero operation and will be set to zero to be used only as placcholders. Taking an example that the number of parameters in the 3D Gaussian parameters is usually 12, in this embodiment, the rows or columns of the input-output convolutional layer network parameters will be copied for n times, so that three-channel weights for processing RGB are migrated to a twelve-channel for processing the 3D Gaussian parameters, and all network weights other than the three-channel weights are copied directly as initialization weights of the target model. The convolutional layer of the text-to-image model, by being fine-tuned, is enabled to directly process 3D Gaussian parameters while the network structure is changed as little as possible. In this embodiment, the priori knowledge of the text-to-image model is fully utilized to enable the adjusted text-to-image model (target model) to directly generate 3D Gaussian parameters.

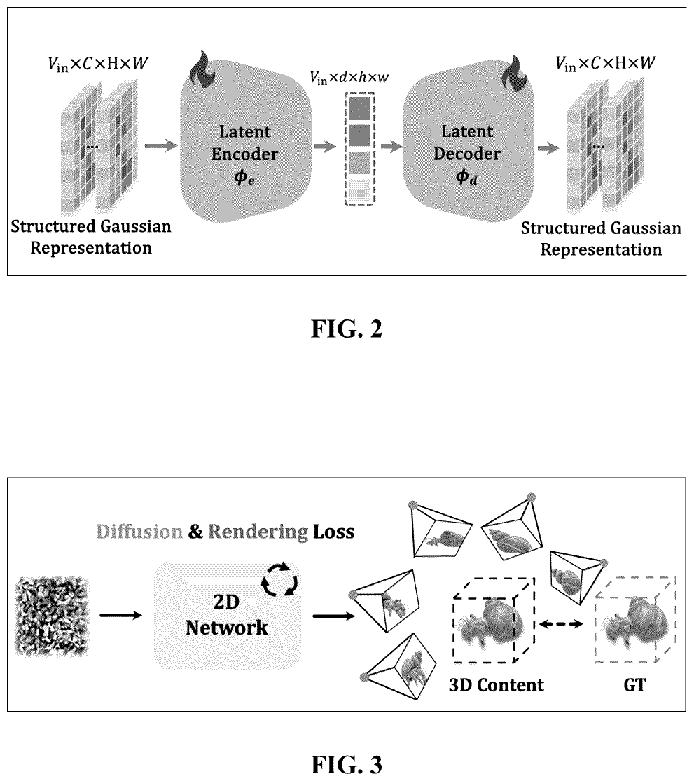

In some embodiments, the text-to-image model comprises a variational encoder and a denoising network. The variational encoder comprises an encoder and a decoder. Since the target model is trained based on the adjusted text-to-image model, the target model also comprises a variational encoder and a denoising network. The variational encoder is usually used in the training stage, and the denoising network is only used in the stage of using the target model. Taking the text-to-image model as an example of Latent Diffusion Models, the input to the encoder of the text-to-image model comprises a 2D image; the output of the encoder of the text-to-image model comprises a latent representation of a 2D image to be input; the input to the decoder of the text-to-image model comprises a latent representation: the output of the decoder of the text-to-image model comprises a 2D image generated based on the input latent representation. To enable both the variational encoder and the denoising network to process the 3D Gaussian parameters, copying rows and columns of the convolutional layer network parameters of the text-to-image model for n times comprises: copying rows and columns of convolutional layer network parameters in the variational encoder of the text-to-image model for n times, and copying rows and columns of convolutional layer network parameters in the denoising encoder of the text-to-image model for n times. Shown in FIG. 2 is the variational encoder of the target model (in FIG. 2, a Latent Encoder is shown on the left and a Latent Decoder is shown on the right). In the text-to-image model, each pixel in the image input to the encoder is represented in terms of three parameters of RBG, so three channels are needed in the text-to-image model to process it: in the target model, each pixel in the image input to the encoder is represented in terms of 3D Gaussian parameters, so twelve channels are usually needed (with the number of parameters in the 3D Gaussian parameters being twelve, for example) in the target model to process it. As shown in FIG. 2, through the above processing, the 3D Gaussian parameters of multi-view images of the same 3D object are organized into a pixel-arranged image format (i.e., Structured Gaussian Representation Structured Gaussian Representation in FIG. 2), and the respective multi-view images are input into the encoder of the target model to be encoded into the latent representations of the 3D Gaussian parameters (Vᵢₙ×d×h×w), and the decoder of the target model is used for rendering the latent representations of the 3D Gaussian parameters to obtain the image.

In some embodiments, training the initialized target model comprises: obtaining multi-view real object images and corresponding text descriptions for training: training a variational encoder of the target model with the multi-view real object images; and training a denoising network of the target model with the multi-view real object images, corresponding text descriptions and the variational encoder; wherein the denoising network of the target model generates 3D Gaussian parameters of respective angles of view respectively based on corresponding text descriptions of the real object images, and concatenates the 3D Gaussian parameters of respective angles of view at an attention layer of the denoising network of the target model to enable the 3D Gaussian parameters of different angles of view to interact with each other.

In some embodiments, an initialized target model is obtained by adjusting the text-to-image model, at which point the target model comprises priori knowledge. Then, the target model needs to be trained using 3D datasets, wherein 3D data comprises multi-view real object images (the object may be a thing, the real object image is a real captured image of the object, e.g., images of an apple in different angles of view), the multi-view read objects are real object images captured from multiple angles of view, respective real object images have corresponding text descriptions. When training the variational encoder, the real object objects of respective angles of view are input to the encoder which then generates 3D Gaussian parameters (may be latent representations of 3D Gaussian parameters). Subsequently, the decoder obtains a rendered image through rendering with the 3D Gaussian parameters generated by the encoder, wherein the difference between the rendered image and the real object image is used for calculating a loss function. Afterwards, parameters are gradually adjusted for iteration, thereby completing the training of the variational encoder. After completion of the training of the variational encoder, the denoising network is trained. Text description of the multi-view real object images are the 3D Gaussian parameter representations generated by the encoder based on the multi-view real object images are input to the denoising network, and the denoising network adds noise to the 3D Gaussian parameters to obtain noise images, and then performs denoising processing on the noise images based on the text descriptions to generate 3D Gaussian parameters (what is generated by the denoising network may be latent representations of the 3D Gaussian parameters). The difference between the 3D Gaussian parameters generated by the denoising network and the 3D Gaussian parameters generated by the encoder and input to the denoising network is denoted as a diffusion loss function for training a denoising network. In the process of training the denoising network, parameters are continuously adjusted to minimize the diffusion loss function. In the training process of this embodiment, the denoising network adds noise to real object images of different angles of view generated by the encoder are input to the denoising network, and then performs denoising to generate 3D Gaussian parameters of different angles of view: The 3D Gaussian parameters of different angles of view generated by the denoising network will interact with each other at a self-attention layer. Specifically, the self-attention layer will concatenate the 3D Gaussian parameters of respective angles of view to enable information of different angles of view to interact with each other, and project these 3D Gaussian parameters to a 3D space to form a representation of 3D Gaussian parameters of a complete 3D object (3D Content in FIG. 3): during the interaction, relationships between the 3D Gaussian parameters of respective angles of view may be compared based on relationships between angles of view, and the 3D Gaussian parameters may be adjusted based on the comparison, so that the 3D Gaussian parameters of different angles of view are consistent with each other and as reasonable as possible.

In some embodiments of the present disclosure, a variational encoder of the target model comprises an encoder and a decoder, the encoder being used for generating 3D Gaussian parameters corresponding to an input image based on the input image, the decoder being used for generating a corresponding image based on input 3D Gaussian parameters: a loss function used in training a denoising network of the target model comprises a diffusion loss function component and a rendering loss function component; the diffusion loss function component is used for characterizing a difference between 3D Gaussian parameters generated by the denoising network of the target model and 3D Gaussian parameters generated by an encoder of the target model; and the rendering loss function component is used for characterizing a difference between a rendered image generated by the decoder using a rasterization technique based on 3D Gaussian parameters generated by the denoising network of the target model and a real object image of a same angle of view.

In some embodiments, during the process of training the target model, a rendering loss function component is additionally used besides the diffusion loss function component. The multi-view real object images are input to the encoder to generate corresponding 3D Gaussian parameters of respective angles of view (which may specifically be a latent representation of the 3D Gaussian parameters), the 3D Gaussian parameters of respective angles of view generated by the encoder are input to the denoising network during training, and then, the denoising network adds noise to them and performs denoising to generate 3D Gaussian parameters of respective angles of view. A loss function, i.e., the diffusion loss function component, will be calculated between the 3D Gaussian parameters generated by the denoising model and the 3D Gaussian parameters input to the denoising model. The 3D Gaussian parameters generated by the denoising model will be further rendered by the decoder to obtain a rendered image, and a loss function, i.e., the rendering loss function component, will be calculated between the rendered image and the real object image input to the encoder. In some embodiments, the rendering loss function component comprises: a mean square error component for measuring a pixel-wise difference, and a perceived similarity metric for a measuring visual similarity:

The diffusion loss function component L_{diffusion} may be denoted as below:

$${ℒ}_{iffusion} := ω ( t ) \cdot {‖ {F}_{θ} ( AddNoise ( x , t , ϵ ) , t , c ) - x ‖}_{2}^{2}$$

Wherein Fa represents an initialized denoising network, x represents original data samples, i.e., 3D Gaussian parameters which are added with noise by the AddNoise function and subsequently subjected to denoising by the denoising network, and the goal of the training is to make a network output as a denoising result be close to the original samples, which is the diffusion loss function component, t represents the degree of added noise, e represents the added random noise, c represents an input textual description, and w (t) represents a weight of the diffusion loss function at different noise degrees.

In this embodiment, the denoising result is rendered into a 2D image at any angle of view, R and Ra represent the micro-rendering process of color difference and transparency respectively, and the rendering result is compared with a real image I and mask M (including mean square error MSE, perceived loss LPIPS) as an additional supervised signal to train the target model, improving geometric consistency and color aesthetics of the model generation. λₐ and λ_{LPIPS} represent weights of the rendering mask loss and the rendering image perceived loss respectively. The rendering loss component L_{render} is characterized as:

$${ℒ}_{render} ( x ) := {ℒ}_{MSE} ( R ( x ) , I ) + {λ}_{α} \cdot {ℒ}_{MSE} ( {R}_{α} ( x ) , M ) + {λ}_{LPIPS} \cdot {ℒ}_{LPIPS} ( R ( x ) , I )$$

The final loss function L of the target model is jointly formed by the diffusion loss function component and the rendering loss function component, Arender represents a weight of the overall rendering loss function component, and wᵣ(t) represents a weight of the rendering loss function component under different noise degrees. The final loss function is denoted as:

$$ℒ := {ℒ}_{diffusion} + {λ}_{render} \cdot {ω}_{r} ( t ) \cdot {ℒ}_{render} ( {F}_{θ} ( AddNoise ( x , t , ϵ ) , t , c ) )$$

In some embodiments, the rendering loss function portion is additionally added to the training process of the target model, taking advantage of the fact that signals processed by the denoising network are differential rendering 3D Gaussian parameters. The feature in the latent space is decoded into a differential rendering 3D representation, so that the image can be rendered in any new angle of view to use the real image as a supervisory signal, independent of the encoder. Moreover, due to the use of 3D Gaussian parameters, its rendering process uses rasterization techniques instead of ray tracing, which greatly improves the efficiency of generating images in training and inference.

In some embodiments of the present disclosure, the method further comprises applying a target application solution adapted to the text-to-image model to the target model: wherein the target application solution comprises one or more of the following: ControlNet, DreamBooth, Rectified Frechet Inception Distance (RectiFID), Adversarial Diffusion Distillation, Distribution Matching Distillation, IP-Adaptor, AnimateAnyone or ControlNeXt.

In some embodiments, the network achitecture of the target model proposed in the present disclosure is almost same as that of the text-to-image model, so the target model proposed in the present disclosure may seamlessly support various target application solutions (usually downstream application techniques) involved in the text-to-image model, i.e., the target model proposed in the present disclosure may be compatible with most of the existing downstream application techniques of the text-to-image model. For example, the technology of ControlNet controlled generation may be migrated to the 3D domain. In specific implementation, like ControlNet for text-to-image applications, the target model of the present disclosure may also utilize a replicated denoising UNet network structure to zero-initialize the up-sampled portion of the UNet, take a desired control signal (e.g., normal vector map, depth map, Canny edge map) as the input, and replicate multiple copies in the dimensions of the angles of view to match the target model's characteristic of simultaneously generating multi-view 3D Gaussian parameters. Besides ControlNet, other technical solutions designed for the text-to-image model may also be migrated to the target model, such as personalized generation techniques DreamBooth, RectifID, distillation acceleration techniques ADD (Adversarial Diffusion Distillation), DMD (Distribution Matching Distillation), editing techniques IP-Adaptor, AnimateAnyone, ControlNeXt, and so on.

In some embodiments of the present disclosure, the text-to-image model which has been pretrained on large-scale datasets is directly used for 3D content generation after being fine-tuned, so that the priori knowledge is fully utilized.

In some embodiments, besides the diffusion loss function component, an additional rendering loss function component is used for training the target model. By using the characteristic that features processed by the denoising network are differential rendering, after the 3D Gaussian parameters are processed by the denoising model, they may be rendered into a 2D image at any angle of view for comparison with a real object as a supervisory signal, which improves geometric consistency and color aesthetics of the 3D content generation.

In some embodiments, due to the structural characteristics of the target model, various 2D image generation techniques may be seamlessly applied to the 3D generation field. Further, by virtue of such a characteristic that the target model has almost same network structure as the text-to-image model, various techniques proposed for image generation downstream tasks such as controlled generation may be used in the field of 3D content generation.

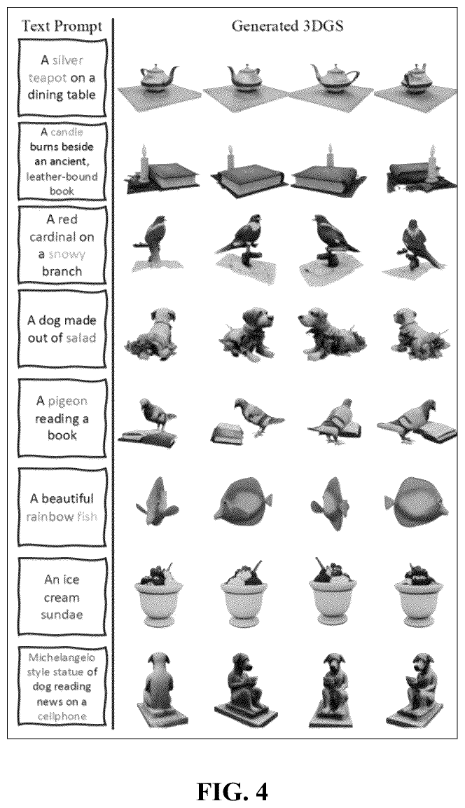

As shown in FIG. 4, target texts input to the target model are shown on the left, and 3D Gaussian parameters (presented as images of the target 3D objects in respective angles of view) of generated target 3D objects are shown on the right. Thanks to the utilization of the priori knowledge of the pretrained text-to-image model, the accuracy of the 3D objects generated from the target text by this embodiment is substantially improved.

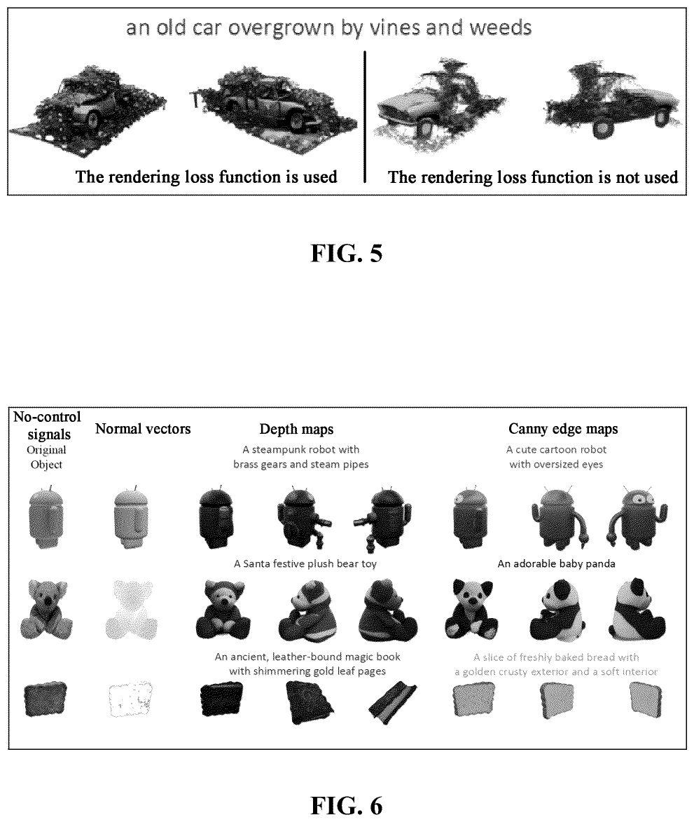

As shown in FIG. 5, the figure shows results of 3D Gaussian parameters generated from the same target text when the target model is trained using the rendering loss function component and is trained without the rendering loss function component. It can be seen that after using the rendering loss function component, the generated target 3D object (in the left of FIG. 5) IS more realistic compared to the target 3D object without using the rendering loss function component (in the right of FIG. 5).

As shown in FIG. 6, the figure shows the target 3D objects which are generated without additionally adding no-control signals as well as using the ControlNet controlled generation technique to add normal vectors, depth, and Canny edge maps as control information numbers. It can be seen that the target model proposed in the present disclosure may seamlessly interface with the ControlNet controlled generation technique, using the ControlNet controlled generation technique in the same manner as the text-to-image model. The normal vector may be used as a control information number to provide information about the normal direction of an object's surface, enhancing geometric detail and lighting consistency. A depth map may be used as a control information number to provide depth information for each pixel in the scene, enhancing the sense of depth and hierarchy. The Canny edge map may be used as a control signal information to provide information about the edges of an object, enhancing edge clarity and contour consistency.

The method provided by the embodiments of the present disclosure, by adjusting the text-to-image model to obtain the target model, can fully utilize the priori knowledge obtained by pretraining the text-to-image model with 2D images and migrate the priori knowledge to a 3D Gaussian generation task.

The present disclosure further proposes an apparatus for generating three-dimensional (3D) Gaussian parameters, comprising:
an obtaining unit configured to obtain a target text, the target text being description text of a target 3D object; and
a control unit configured to input the target text into a pretrained target model to cause the target model to generate 3D Gaussian parameters of a target 3D object conforming to the target text;
wherein the pretrained target model is obtained by adjusting a pretrained text-to-image model to obtain an initialized target model and then training the initialized target model; and
the text-to-image model is a model for generating, based on an input text, a two-dimensional (2D) image conforming to the input text.

In some embodiments, adjusting the pretrained text-to-image model to obtain the initialized target model comprises:
obtaining the pretrained text-to-image model;
copying rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and
determining the text-to-image model with the adjusted convolutional layer as the initialized target model.

In some embodiments, the text-to-image model comprises a variational encoder and a denoising network; and

copying rows and columns of the convolutional layer network parameters of the text-to-image model for n times comprises: copying rows and columns of convolutional layer network parameters in the variational encoder of the text-to-image model for n times, and copying rows and columns of convolutional layer network parameters in the denoising encoder of the text-to-image model for n times.

In some embodiments, training the initialized target model comprises:
obtaining multi-view real object images and corresponding text descriptions for training;
training a variational encoder of the target model with the multi-view real object images; and
training a denoising network of the target model with the multi-view real object images, corresponding text descriptions and the variational encoder;
wherein the denoising network of the target model generates 3D Gaussian parameters of respective angles of view respectively based on corresponding text descriptions of the real object images, and concatenates the 3D Gaussian parameters of respective angles of view at an attention layer of the denoising network of the target model to enable the 3D Gaussian parameters of different angles of view to interact with each other.

In some embodiments, a variational encoder of the target model comprises an encoder and a decoder, the encoder being used for generating 3D Gaussian parameters corresponding to an input image based on the input image, the decoder being used for generating a corresponding image based on an input 3D Gaussian parameter;
a loss function used in training a denoising network of the target model comprises a diffusion loss function component and a rendering loss function component;
the diffusion loss function component is used for characterizing a difference between 3D Gaussian parameters generated by the denoising network of the target model and 3D Gaussian parameters generated by an encoder of the target model; and
the rendering loss function component is used for characterizing a difference between a rendered image generated by the decoder using a rasterization technique based on 3D Gaussian parameters generated by the denoising network of the target model and a real object image of a same angle of view.

In some embodiments, the rendering loss function component comprises: a mean square error component for measuring a pixel-wise difference, and a perceived similarity metric for a measuring visual similarity:

In some embodiments, the control unit is further configured to apply a target application solution adapted to the text-to-image model to the target model;
wherein the target application solution comprises one or more of the following: ControlNet, DreamBooth, Rectified Frechet Inception Distance (RectiFID), Adversarial Diffusion Distillation, Distribution Matching Distillation, IP-Adaptor, AnimateAnyone or ControlNeXt.

For the apparatus embodiment, since it substantially corresponds to the method embodiment, reference may be made to the description of the method embodiment for related parts. The apparatus embodiment described above is merely illustrative, wherein the module illustrated as a separate module may be or may not be separate. Part or all of the modules may be selected based on actual needs to accomplish the goal of the solution of this embodiment. Those of ordinary skill in the art may understand and implement the technical solution without the exercise of any inventive skill.

The method and apparatus of the present disclosure have been illustrated based on the embodiments and application examples. In addition, the present disclosure further provides an electronic device and computer readable storage medium, which are to be described below.

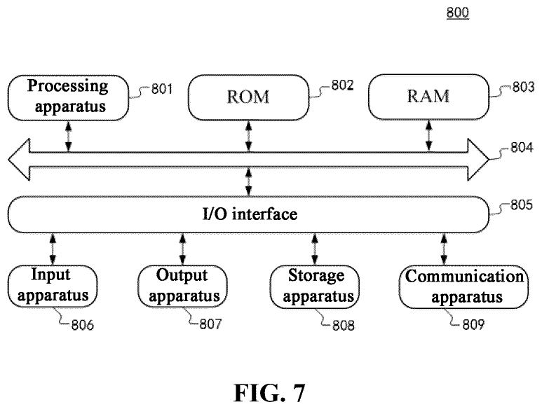

With reference to FIG. 7, this figure shows a structural schematic diagram of an electronic device (e.g., a terminal device or a server) 800 which is applicable to implement the embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer and the like. The electronic device shown in the figure is merely an example and may not be construed as bringing any restriction on the functionality and usage scope of the embodiments of the present disclosure.

The electronic device 800 may comprise a processing apparatus (e.g., a central processor, a graphics processor) 801 which is capable of performing various appropriate actions and processes as described in the embodiments of the present disclosure in accordance with programs stored in a read only memory (ROM) 802 or programs loaded from a storage apparatus 808 to a random access memory (RAM) 803. In the RAM 803, there are also stored various programs and data required by the electronic device 800 when operating. The processing apparatus 801, the ROM 802 and the RAM 803 are connected to one another via a bus 804. An input/output (I/O) interface 805 is also connected to the bus 804.

Typically, the following units may be connected to the I/O interface 805: an input apparatus 806 including, for example, a touchscreen, a touch pad, a keyboard, a mouse, a camera, a microphone, an accelerometer, a gyroscope and the like; an output apparatus 807 including, for example, a Liquid Crystal Display (LCD), a loudspeaker, a vibrator and the like; a storage apparatus 808 including, for example, a tape, a hard drive and the like; and a communication apparatus 809. The communication apparatus 809 can allow wireless or wired communication of the electronic device 800 with other devices to exchange data. Although FIG. 7 shows the terminal device 800 with various apparatuses, it is to be understood that it is not required to implement or have all of the illustrated apparatuses. Alternatively, more or less apparatuses may be implemented or exist.

In particular, according to embodiments of the present disclosure, the processes described above with reference to the flowcharts may be implemented as computer software programs. For example, embodiments of the present disclosure include a computer program product comprising a computer program carried on a non-transitory computer readable medium, the computer program containing program code for performing the methods as in the flowcharts. In those embodiments, the computer program may be downloaded and installed from a network via the communication apparatus 809, or may be installed from the storage apparatus 808, or may be installed from the ROM 802. The computer program, when executed by the processing apparatus 801, performs the above-described functions defined in the method according to the embodiments of the present disclosure.

It is to be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some implementations, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer readable medium may be the one included in the electronic device, or may be provided separately, rather than assembled in the electronic device.

The computer readable medium carries one or more programs which, when executed by the electronic device, cause the electronic device to: obtain current video data to be uploaded; determine a target first slice data amount matching a current upload network based on historical upload network information; and slice the current video data based on the target first slice data amount to obtain a current video slice to be uploaded currently, and upload the current video slice

Computer program codes for carrying out operations of the present disclosure may be written in one or more programming languages, including without limitation to, an object oriented programming language such as Java. Smalltalk. C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality; and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It is to also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs). Application-specific Integrated Circuits (ASICs). Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine-readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, a method of generating three-dimensional (3D) Gaussian parameters is provided, comprising:
obtaining a target text, the target text being a description text of a target 3D object; and
inputting the target text into a pretrained target model to cause the target model to generate 3D Gaussian parameters of a target 3D object conforming to the target text;
wherein the pretrained target model is obtained by adjusting a pretrained text-to-image model to obtain an initialized target model and then training the initialized target model; and
the text-to-image model is a model for generating, based on an input text, a two-dimensional (2D) image conforming to the input text.

According to one or more embodiments of the present disclosure, a method of generating three-dimensional (3D) Gaussian parameters is provided, wherein adjusting the pretrained text-to-image model to obtain the initialized target model comprises:
obtaining the pretrained text-to-image model;
copying rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and
determining the text-to-image model with the adjusted convolutional layer as the initialized target model.

According to one or more embodiments of the present disclosure, a method of generating three-dimensional (3D) Gaussian parameters is provided, wherein the text-to-image model comprises a variational encoder and a denoising network; and
copying rows and columns of the convolutional layer network parameters of the text-to-image model for n times comprises: copying rows and columns of convolutional layer network parameters in the variational encoder of the text-to-image model for n times, and copying rows and columns of convolutional layer network parameters in the denoising encoder of the text-to-image model for n times.

According to one or more embodiments of the present disclosure, a method of generating three-dimensional (3D) Gaussian parameters is provided, wherein training the initialized target model comprises: obtaining multi-view real object images and corresponding text descriptions for training;
training a variational encoder of the target model with the multi-view real object images; and
training a denoising network of the target model with the multi-view real object images, corresponding text descriptions and the variational encoder;
wherein the denoising network of the target model generates 3D Gaussian parameters of respective angles of view respectively based on corresponding text descriptions of the real object images, and concatenates the 3D Gaussian parameters of respective angles of view at an attention layer of the denoising network of the target model to enable the 3D Gaussian parameters of different angles of view to interact with each other.

According to one or more embodiments of the present disclosure, a method of generating three-dimensional (3D) Gaussian parameters is provided, wherein a variational encoder of the target model comprises an encoder and a decoder, the encoder being used for generating 3D Gaussian parameters corresponding to an input image based on the input image, the decoder being used for generating a corresponding image based on an input 3D Gaussian parameter;
a loss function used in training a denoising network of the target model comprises a diffusion loss function component and a rendering loss function component;
the diffusion loss function component is used for characterizing a difference between 3D Gaussian parameters generated by the denoising network of the target model and 3D Gaussian parameters generated by an encoder of the target model; and
the rendering loss function component is used for characterizing a difference between a rendered image generated by the decoder using a rasterization technique based on 3D Gaussian parameters generated by the denoising network of the target model and a real object image of a same angle of view.

According to one or more embodiments of the present disclosure, a method of generating three-dimensional (3D) Gaussian parameters is provided, wherein the rendering loss function component comprises: a mean square error component for measuring a pixel-wise difference, and a perceived similarity metric for a measuring visual similarity:

According to one or more embodiments of the present disclosure, a method of generating three-dimensional (3D) Gaussian parameters is provided, further comprising:
applying a target application solution adapted to the text-to-image model to the target model;
wherein the target application solution comprises one or more of the following: ControlNet, DreamBooth, Rectified Frechet Inception Distance (RectiFID), Adversarial Diffusion Distillation, Distribution Matching Distillation, IP-Adaptor, AnimateAnyone or ControlNeXt.

According to one or more embodiments of the present disclosure, an apparatus for generating three-dimensional (3D) Gaussian parameters is provided, comprising:
an obtaining unit configured to obtain a target text, the target text being description text of a target 3D object; and
a control unit configured to input the target text into a pretrained target model to cause the target model to generate 3D Gaussian parameters of a target 3D object conforming to the target text;
wherein the pretrained target model is obtained by adjusting a pretrained text-to-image model to obtain an initialized target model and then training the initialized target model; and
the text-to-image model is a model for generating, based on an input text, a two-dimensional (2D) image conforming to the input text.

According to one or more embodiments of the present disclosure, an electronic device is provided, comprising: at least one memory and at least one processor;
wherein the at least one memory is configured to store program codes, and the at least one processor is configured to call program codes stored in the at least one memory to perform a method of any of claims 1-7.

According to one or more embodiments of the present disclosure, a computer readable storage medium is provided, the computer readable storage medium configured to store program codes which, when run by a processor, cause the processor to perform a method described above.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombinations.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

I/We claim:

1. A method of generating three-dimensional (3D) Gaussian parameters, comprising:
obtaining a target text, the target text being a description text of a target 3D object; and
inputting the target text into a pretrained target model to cause the target model to generate 3D Gaussian parameters of a target 3D object conforming to the target text,
wherein the pretrained target model is obtained by adjusting a pretrained text-to-image model to obtain an initialized target model and then training the initialized target model, and
wherein the text-to-image model is a model for generating, based on an input text, a two-dimensional (2D) image conforming to the input text.

2. The method of claim 1, wherein adjusting the pretrained text-to-image model to obtain the initialized target model comprises:
obtaining the pretrained text-to-image model;
copying at least one of rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and
determining the text-to-image model with the adjusted convolutional layer as the initialized target model.

3. The method of claim 2, wherein at least one of the following:
the text-to-image model comprises a variational encoder and a denoising network: or copying rows and columns of the convolutional layer network parameters of the text-to-image model for n times comprises:
copying rows and columns of convolutional layer network parameters in the variational encoder of the text-to-image model for n times, and
copying rows and columns of convolutional layer network parameters in the denoising encoder of the text-to-image model for n times.

4. The method of claim 1, wherein training the initialized target model comprises:
obtaining multi-view real object images and corresponding text descriptions for training;
training a variational encoder of the target model with the multi-view real object images; and
training a denoising network of the target model with the multi-view real object images, corresponding text descriptions and the variational encoder,
wherein the denoising network of the target model generates 3D Gaussian parameters of respective angles of view respectively based on corresponding text descriptions of the real object images, and concatenates the 3D Gaussian parameters of respective angles of view at an attention layer of the denoising network of the target model to enable the 3D Gaussian parameters of different angles of view to interact with each other.

5. The method of claim 1, wherein at least one of the following:
a variational encoder of the target model comprises an encoder and a decoder, the encoder being used for generating 3D Gaussian parameters corresponding to an input image based on the input image, the decoder being used for generating a corresponding image based on input 3D Gaussian parameters;
a loss function used in training a denoising network of the target model comprises a diffusion loss function component and a rendering loss function component;
the diffusion loss function component is used for characterizing a difference between 3D Gaussian parameters generated by the denoising network of the target model and 3D Gaussian parameters generated by an encoder of the target model; or
the rendering loss function component is used for characterizing a difference between a rendered image generated by the decoder using a rasterization technique based on 3D Gaussian parameters generated by the denoising network of the target model and a real object image of a same angle of view.

6. The method of claim 5, wherein the rendering loss function component comprises:
a mean square error component for measuring a pixel-wise difference; and
a perceived similarity metric for a measuring visual similarity.

7. The method of claim 1, further comprising:
applying a target application solution adapted to the text-to-image model to the target model,
wherein the target application solution comprises one or more of the following;
ControlNet, DreamBooth, Rectified Frechet Inception Distance (RectiFID), Adversarial Diffusion Distillation, Distribution Matching Distillation, IP-Adaptor, AnimateAnyone or ControlNeXt.

8. An electronic device, comprising:
at least one memory; and
at least one processor,
and wherein the at least one memory stores processor executable instructions which, when executed by the at least one processor, cause the at least one processors to:
obtain a target text, the target text being a description text of a target 3D object; and
input the target text into a pretrained target model to cause the target model to generate 3D Gaussian parameters of a target 3D object conforming to the target text,
wherein the pretrained target model is obtained by adjusting a pretrained text-to-image model to obtain an initialized target model and then training the initialized target model, and
wherein the text-to-image model is a model for generating, based on an input text, a two-dimensional (2D) image conforming to the input text.

9. The electronic device of claim 8, wherein the instructions to adjust the pretrained text-to-image model to obtain the initialized target model comprise instructions to:
obtain the pretrained text-to-image model;
copy at least one of rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and
determine the text-to-image model with the adjusted convolutional layer as the initialized target model.

10. The electronic device of claim 9, wherein at least one of the following:
the text-to-image model comprises a variational encoder and a denoising network: or
the instructions to copy rows and columns of the convolutional layer network parameters of the text-to-image model for n times comprise instructions to:
copy rows and columns of convolutional layer network parameters in the variational encoder of the text-to-image model for n times, and
copy rows and columns of convolutional layer network parameters in the denoising encoder of the text-to-image model for n times.

11. The electronic device of claim 8, wherein the instructions to train the initialized target model comprise instructions to:
obtain multi-view real object images and corresponding text descriptions for training;
train a variational encoder of the target model with the multi-view real object images; and
train a denoising network of the target model with the multi-view real object images, corresponding text descriptions and the variational encoder,
wherein the instructions further comprises instructions to:
cause the denoising network of the target model generate 3D Gaussian parameters of respective angles of view respectively based on corresponding text descriptions of the real object images, and cause the denoising network of the target model concatenate the 3D Gaussian parameters of respective angles of view at an attention layer of the denoising network of the target model to enable the 3D Gaussian parameters of different angles of view to interact with each other.

12. The electronic device of claim 8, wherein at least one of the following:
a variational encoder of the target model comprises an encoder and a decoder, the encoder being used for generating 3D Gaussian parameters corresponding to an input image based on the input image, the decoder being used for generating a corresponding image based on input 3D Gaussian parameters;
a loss function used in training a denoising network of the target model comprises a diffusion loss function component and a rendering loss function component;
the diffusion loss function component is used for characterizing a difference between 3D Gaussian parameters generated by the denoising network of the target model and 3D Gaussian parameters generated by an encoder of the target model; or
the rendering loss function component is used for characterizing a difference between a rendered image generated by the decoder using a rasterization technique based on 3D Gaussian parameters generated by the denoising network of the target model and a real object image of a same angle of view.

13. The electronic device of claim 12, wherein the rendering loss function component comprises:
a mean square error component for measuring a pixel-wise difference; and
a perceived similarity metric for a measuring visual similarity.

14. The electronic device of claim 8, wherein the instructions further comprise instructions to:
apply a target application solution adapted to the text-to-image model to the target model,
wherein the target application solution comprises one or more of the following:
ControlNet, DreamBooth, Rectified Frechet Inception Distance (RectiFID), Adversarial Diffusion Distillation, Distribution Matching Distillation, IP-Adaptor, AnimateAnyone or ControlNeXt.

15. A non-transitory computer readable storage medium storing computer executable instructions, wherein the instructions, when executed by a processor, cause the processor to:
obtain a target text, the target text being a description text of a target 3D object; and
input the target text into a pretrained target model to cause the target model to generate 3D Gaussian parameters of a target 3D object conforming to the target text,
wherein the pretrained target model is obtained by adjusting a pretrained text-to-image model to obtain an initialized target model and then training the initialized target model, and
wherein the text-to-image model is a model for generating, based on an input text, a two-dimensional (2D) image conforming to the input text.

16. The non-transitory computer readable storage medium of claim 15, wherein the instructions to adjust the pretrained text-to-image model to obtain the initialized target model comprise instructions to:
obtain the pretrained text-to-image model;
copy at least one of rows or columns of convolutional layer network parameters of the text-to-image model for n times, wherein a product of 3 times n is equal to a smallest positive integer that is not less than a number of parameters of the 3D Gaussian parameters, and all other network weights other than the convolutional layer in the text-to-image model remain unchanged; and
determine the text-to-image model with the adjusted convolutional layer as the initialized target model.

17. The non-transitory computer readable storage medium of claim 16, wherein at least one of the following:
the text-to-image model comprises a variational encoder and a denoising network: or
the instructions to copy rows and columns of the convolutional layer network parameters of the text-to-image model for n times comprise instructions to:
copy rows and columns of convolutional layer network parameters in the variational encoder of the text-to-image model for n times, and
copy rows and columns of convolutional layer network parameters in the denoising encoder of the text-to-image model for n times.

18. The non-transitory computer readable storage medium of claim 15, wherein the instructions to train the initialized target model comprise instructions to:
obtain multi-view real object images and corresponding text descriptions for training;
train a variational encoder of the target model with the multi-view real object images; and
train a denoising network of the target model with the multi-view real object images, corresponding text descriptions and the variational encoder,
wherein the instructions further comprises instructions to:
cause the denoising network of the target model generate 3D Gaussian parameters of respective angles of view respectively based on corresponding text descriptions of the real object images, and cause the denoising network of the target model concatenate the 3D Gaussian parameters of respective angles of view at an attention layer of the denoising network of the target model to enable the 3D Gaussian parameters of different angles of view to interact with each other.

19. The non-transitory computer readable storage medium of claim 15, wherein at least one of the following:
a variational encoder of the target model comprises an encoder and a decoder, the encoder being used for generating 3D Gaussian parameters corresponding to an input image based on the input image, the decoder being used for generating a corresponding image based on input 3D Gaussian parameters;
a loss function used in training a denoising network of the target model comprises a diffusion loss function component and a rendering loss function component;
the diffusion loss function component is used for characterizing a difference between 3D Gaussian parameters generated by the denoising network of the target model and 3D Gaussian parameters generated by an encoder of the target model; or
the rendering loss function component is used for characterizing a difference between a rendered image generated by the decoder using a rasterization technique based on 3D Gaussian parameters generated by the denoising network of the target model and a real object image of a same angle of view.

20. The non-transitory computer readable storage medium of claim 19, wherein the rendering loss function component comprises:
a mean square error component for measuring a pixel-wise difference; and
a perceived similarity metric for a measuring visual similarity.
